(19) United States
(12) Patent Application Publication
(10) Pub. No.: US 2009/0178126 A1
(43) Pub. Date: Jul. 9, 2009

(54) SYSTEMS AND METHODS FOR PROVIDING USER-FRIENDLY COMPUTER SERVICES

(76) Inventors: Sterling DU, Palo Alto, CA (US); Shaolan WANG, Beijing (CN); Hongning ZENG, Beijing (CN)

Correspondence Address: O2MICRO INC;C/O MURABITO, HAO & BARNES LLP, TWO NORTH MARKET STREET, THIRD FLOOR, SAN JOSE, CA, 95113, US

(21) Appl. No.: 12/345,168

(22) Filed: Dec. 29, 2008

Related U.S. Application Data
(60) Provisional application No. 61/009,901, filed on Jan. 3, 2008.

(51) Int. Cl. H04L 9/32

(52) U.S. Cl. 726/6

(57) ABSTRACT

A system for providing computer services includes a camera and an electronic device. The camera obtains recognition information for a user. The electronic device is operable for executing a first operating system for conducting user authentication according to the recognition information and for automatically operating a user-defined application program after the user passes said user authentication.

### RELATED APPLICATION

This application claims priority to the copending provisional patent application, Ser. No. 61/009,901, Docket Number 02-0486.PRO, entitled “Systems and Methods for Providing User-Friendly Computer Services,” with filing date Jan. 3, 2008, assigned to the assignee of the present application, and hereby incorporated by reference in its entirety.

### BACKGROUND

Nowadays, personal computers are affordable and nearly every family has a computer. A computer provides a lot of entertainment and convenience to users. However, not all the members in a family can enjoy the entertainment and convenience provided by the computer. In some general instances, members of the family who have not taken computer courses may not know how to use the computer. To those people, operating a computer might be troublesome and inconvenient.

In addition, if a user wants to use the computer to make an Internet phone call, a lot of operations may need to be done before making the phone call. For instance, the user may need to first start up the computer, and enter a username and password before the operating system can be loaded. In some cases, if the user cannot remember the username or the password, the operating system cannot be loaded. After loading the operating system, the user may need to be connected online to get a particular online service. For example, the user may open, from a program list including all the applications installed in the computer, a software application (e.g., SKYPE) which is capable of providing Internet phone call services. Furthermore, the user may need to enter a username and a password every time the software application (e.g., SKYPE) is used. All these operations can frustrate users who are not familiar with computers and as a result can deprive them of the convenience that Internet phone calls bring.

### SUMMARY

Embodiments of the present invention provide systems and methods for providing computer services. In one embodiment, the system includes a camera and an electronic device. The camera obtains recognition information for a user. The electronic device is operable for executing a first operating system for conducting user authentication according to the recognition information and for automatically operating a user-defined application program after the user passes the user authentication.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of system that provides user-friendly computer services according to an embodiment of the present invention.

FIG. 2 is a block diagram of electronic device according to an embodiment of the present invention.

FIG. 3 is a flowchart of a method for making an Internet phone call according to one embodiment of the present invention.

FIG. 4 is a flowchart of a method for browsing websites according to one embodiment of the present invention.

FIG. 5 is a flowchart of a method for playing an audio or video file according to one embodiment of the present invention.

FIG. 6 is a flowchart of a method for making a video phone call according to one embodiment of the present invention.

FIG. 7 is a flowchart of a method for providing user-friendly computer services according to one embodiment of the present invention.

### DETAILED DESCRIPTION

Reference will now be made in detail to embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “obtaining,” “starting,” “loading,” “displaying” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

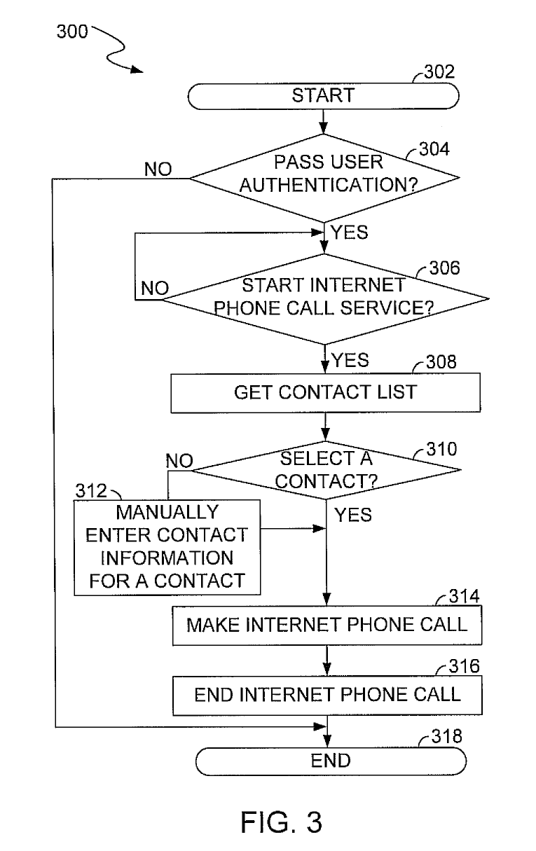

FIGS. 3, 4, 5, 6 and 7 are flowcharts of examples of computer-implemented methods according to embodiments of the present invention. The flowcharts of FIGS. 3-7 can be implemented as computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

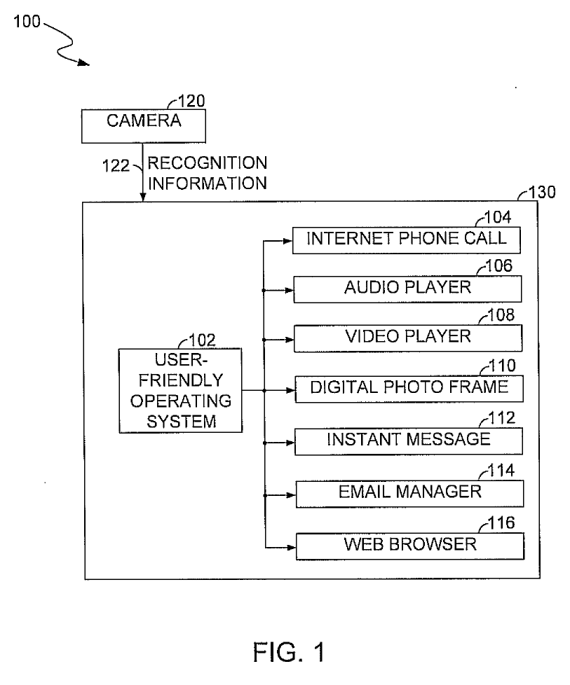

FIG. 1 illustrates a block diagram of a system 100 for providing user-friendly computer services according to one embodiment of the present invention. The system 100 includes a camera 120 and an electronic device 130. The electronic device 130 includes a user-friendly operating system (OS) 102, and one or more application programs for providing user-friendly computer services. The application programs may include, but are not limit to, Internet phone call application 104, audio player 106, video player 108, digital photo frame application 110, instant message application 112, email manager 114, Web browser 116, etc. In one embodiment, the electronic device 130 is a computer. The camera 120 coupled to the electronic device 130 obtains recognition information 122 from and for a user of the electronic device 130 and provides the recognition information 122 to the electronic device 130. In one embodiment, the camera 120 is embedded in the electronic device 130.

The system 100 can provide computer services by operating the application programs. For example, the Internet phone call application program 104 (e.g., SKYPE) can provide an on-line phone call service. The audio player application program 106 (e.g., Winamp) can play audio files stored in the computer or disks attached to the computer. The video player application program 108 (e.g., WINDOWS Media Player) can play video files stored in the computer or disks attached to the computer. The digital photo frame application program 110 can display slide shows of image files stored in the computer or disks attached to the computer. The instant message application program 112 (e.g., MSN Messenger) can establish online message communication. The email manager application program 114 (e.g., MICROSOFT OUTLOOK) can provide an email management service. The Web browser application program 116 (e.g., MICROSOFT INTERNET EXPLORER) can provide Web page browsing services and enable the user to surf the World Wide Web.

Furthermore, the system 100 can provide other services, e.g., a graphical user interface (GUI) and user authentication, to the application programs (e.g., Internet phone call application 104, audio player 106, video player 108, digital photo frame application 110, instant message application 112, email manager 114, Web browser 116, etc.). The GUI is an interface for issuing commands to the computer utilizing a pointing device, such as a mouse, which can manipulate and activate graphical images on a monitor (screen). The user authentication process verifies the identity of a user according to the recognition information 122 provided by the camera 120. The application programs, such as those mentioned above, access these services through application programming interfaces or system calls. By invoking the application programming interfaces, the application programs can request services from the user-friendly operating system 102, pass parameters, and receive results of an operation. Users may also interact with the user-friendly operating system 102 by pushing specific buttons, typing commands, or using the graphical user interface.

Advantageously, the user authentication service provided by the user-friendly operating system 102 includes a face recognition service. The user-friendly operating system 102 obtains a user's face image via the camera 120. The user-friendly operating system 102 can recognize the user by the facial characteristics in the user's face image. If the user authentication service authenticates the user, the user-friendly operating system 102 will automatically start up and load the user's settings. Furthermore, the user-friendly operating system 102 can automatically start up the application programs in a customized application program list right after logging into the user-friendly operating system 102.

In one embodiment, the user's settings may include, but are not limited to, a customized visual style of the graphical user interface; a customized application program list; a first username, a first password, and a first contact list for the application program Internet phone call application 104; an audio file list for the audio player application program 106; an video file list for the video player application program 108; an image file list for the digital photo frame application program 110; a second username, a second password, and a second contact list for the instant message application program 112; and a third username, a third password, and an email address book for the email manager application program 114. These settings can be set by the user or an administrator of the computer beforehand. The user can edit the user's own settings, and/or the administrator can edit settings for all the users of the user-friendly operating system 102, in one embodiment. Furthermore, the customized visual style of the graphical user interface can be edited according to the user's requirements. For example, for a user who cannot utilize the mouse adroitly, the visual style of the graphical user interface can be edited to have bigger icons displayed on the screen.

As a result, user-friendly operating system 102 enables the user with little computer knowledge to conveniently use application programs. The user does not need to memorize any username or password to log into the user-friendly operating system 102 or any of the application programs, in one embodiment. In one embodiment, the user only needs to present his or her face to the camera and complete the facial authentication process for logging into the user-friendly operating system 102, and the application programs in the customized application program list will be automatically started by the user-friendly operating system 102. The user-friendly operating system 102 and the application programs listed in the customized application program list can start up automatically. The user does not need to find the application program that he/she wants to use from all applications installed in the computer, in one embodiment. Furthermore, the application programs can be displayed on the screen in a manner that the user prefers, which can make the use of the application programs more convenient to the user.

The following example will show how a user (e.g., USER1) uses the Internet phone call application program 104 (e.g., SKYPE) by means of a computer having the user-friendly operating system 102. USER1 pushes a power button of the computer. The power button can be the conventional power button of the computer or a different power button specifically used for starting the user-friendly operating system 102. The camera 120 obtains a face image of USER1. The user-friendly operating system 102 enables the facial authentication function and loads the settings associated with USER1. The settings of USER1 can be set by USER1 beforehand. The settings of USER1 can also be set by an administrator of the computer who has more knowledge about operating the computer. For example, if USER1 uses only the Internet phone call application program 104 regularly, the customized application program list can contain only Internet phone call application program 104. The user-friendly operating system 102 connects the computer to the Internet, starts the Internet phone call application program 104, and fills in the username and the password of USER1 to automatically sign into the Internet phone call application program 104. Within seconds, a contact list of USER1 can be displayed on the screen. The contact list can be made by USER1 or the administrator of the computer beforehand. The contact list can be a list of names of the contacts. The contact list can also contain photos of the contacts so that the user does not have to read the names in the list. USER1 chooses one contact from the contact list and the Internet phone call application program 104 can establish connection with the contact.

Furthermore, if the contact also has a camera, then during the phone call the video image of the contact can be shown on the screen. As such, both regular Internet phone calls and video phone calls can be made. In one embodiment, the only operations USER1 has to make are pushing the power button and choosing a contact, making the process easy and convenient to complete. Moreover, the Internet phone call application program 104 can dial a conventional phone or a cell phone and can establish an Internet communication between two users of the Internet phone call application program 104. Generally, an Internet phone call between two users of the Internet phone call application program 104 is free or relatively inexpensive.

The following example will further show how a user (e.g., USER2) uses the application programs (e.g., Internet phone call application 104, audio player 106, video player 108, digital photo frame application 110, instant message application 112, email manager 114, Web browser 116, etc.) by means of the computer having the user-friendly operating system 102. As described above, USER2 pushes the power button of the computer. The user-friendly operating system 102 enables the user authentication function and loads settings associated with USER2. For example, the customized application program list of USER2 may contain application programs including audio player 106, video player 108, digital photo frame application 110, instant message application 112, email manager 114, and Web browser 116. The user-friendly operating system 102 connects the computer to the Internet, and starts one or more of the aforementioned application programs. Meanwhile, the user-friendly operating system 102 also automatically fills in the usernames and the passwords of USER2 to sign into, for example, the application programs for instant messenger 112 and email manager 1 14. Within seconds, these application programs can be shown on the screen.

For example, these application programs will be shown as names or icons on the screen for USER2 to select. If USER2 wants to listen to music, USER2 can select the icon of audio player application program 106. In one embodiment, an audio file list which contains USER2's favorite music will be displayed on the screen. The audio file list can be made by USER2 or the administrator of the computer beforehand. USER2 can select the music from the audio file list and the music will be played. In one embodiment, the audio player application program 106 can also automatically play the audio file listed in the audio file list. Thus, USER2 does not need to find the music from files stored in the computer. As such, even if USER2 does not know how to explore local disks or removable disks attached to the computer, USER2 can still enjoy the music. Furthermore, USER2 can enjoy video entertainment by means of the video player application program 108, and browse digital pictures by means of the digital photo frame application program 110 in a similar way.

Similarly, if USER2 wants to browse websites, USER2 can select the icon of the Web browser application program 116. A website list which contains USER2's favorite websites will be displayed on the screen. The websites list can be made by USER2 or the administrator of the computer beforehand. USER2 can select a website from the websites list and Web pages of the website will be opened. As such, even if USER2 does not remember the addresses of the websites, USER2 can still visit his/her favorite websites. Furthermore, the user-friendly operating system 102 can automatically connect the computer to the Internet.

Moreover, the digital photo frame application program 110 can search for photos by means of the facial authentication information provided by the user-friendly operating system 102. For example, if USER2 wants to see his or her photos, USER2 can initiate a search and the user-friendly operating system 102 will compare the face image of USER2 obtained by the camera 120 with the photos stored in the computer. After comparing, a photo list will be shown on the screen. USER2 can select from the photo list to browse the photos. The digital photo frame application program 110 can also automatically display a slide show of the photos.

The user-friendly operating system 102 can start up and sign into the application programs for instant message 112 and email manager 114 in a similar way as for the Internet phone call application program 104. Furthermore, an alert for a received phone call from the Internet phone call application program 104, an alert for an instant message from the instant message application program 112, and an alert for new email from the email manager application program 114 will be shown instantly on the screen while any other application program is running. As such, USER2 does not need to check these application programs from time to time to see if there is any phone call, message, or new email coming.

Advantageously, the user-friendly operating system 102, which may also be referred to herein as the first operating system, can be embedded in another operating system (e.g., LINUX, WINDOWS), which may referred to herein as the second operating system. The user-friendly operating system 102 can be started before the second operating system conducts user authentication. Alternatively, the user-friendly operating system 102 can be an individual (stand-alone) operating system. The user can select the user-friendly operating system 102 from among other operating systems installed in the computer when starting up the computer. The user can also set the user-friendly operating system 102 as the default operating system. Also, the user can push a specified power button to start up the user-friendly operating system 102. Moreover, when the user-friendly operating system 102 is started, the user can switch to another operating system by operating a certain item (not shown in FIG. 1) without restarting the computer. In one embodiment, the certain item can be an icon displayed on the monitor. In other embodiment, the certain item can be a specified button on the computer.

In one embodiment, the user-friendly operating system 102 is capable of performing power management to save power. For example, after facial authentication, the user-friendly operating system 102 starts up only the application programs in the customized application program list. As a result, in one embodiment, only hardware necessary for running the application programs in the customized application program list will be in a functional state (e.g., powered on) and the other hardware will maintain an idle state (e.g., not powered). In other words, the user-friendly operating system 102 can place the central processing unit (CPU), peripheral chips, hard disk driver (HDD) and other hardware of the computer into the idle state when they are not needed. As such, the user-friendly operating system 102 can reduce power usage of the computer. When the computer is a laptop computer using a battery, the user-friendly operating system 102 can save battery power and extend the length of time that the battery maintains sufficient capacity to power the laptop computer.

In one embodiment, the user-friendly operating system 102 can be applied to (implemented on) a digital photo frame device. The digital photo frame device is an electronic device having a mechanical and physical form similar to that of a conventional photo frame. However, the digital photo frame displays digital photos on a liquid crystal display (LCD) screen. The digital photos can be stored in a memory of the digital photo frame device. The user-friendly operating system 102 can be implemented in the digital photo frame device cooperating with a camera mounted in the digital photo frame device. The digital photo frame device displays photos stored in its memory or streamed to it from another device. In one embodiment, when a user stands in front of the digital photo frame device, the user-friendly operating system 102 can obtain a face image of the user via the camera 120, conduct user authentication by comparing the face image of the user with the photos stored in the digital photo frame device, and control the digital photo frame device to display the user's photos on the LCD screen.

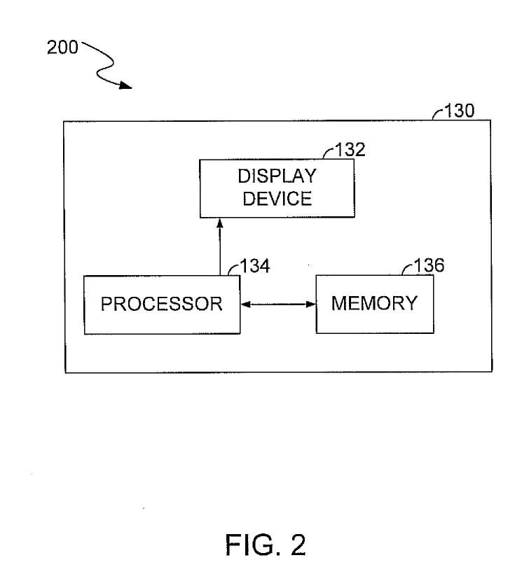

FIG. 2 illustrates a block diagram 200 of the electronic device 130 in the FIG. 1 according to one embodiment of the present invention. The electronic device 130 includes a display device 132, a processor 134 and a memory 136. The memory 136 stores programs and data. The processor 134 executes operations which are defined by the programs stored in the memory 136 and outputs operation results to the display device 132 which will display the results in a user-defined format, such as screen display, document print and voice. In an embodiment in which the electronic device 130 is a computer, the display device 132 can be a monitor.

FIG. 3 illustrates a flowchart 300 of a method for making an Internet phone call according to one embodiment of the present invention. Although specific steps are disclosed in FIG. 3, such steps are exemplary. That is, the present invention is well suited to performing various other steps or variations of the steps recited in FIG. 3. FIG. 3 is described in combination with FIG. 1.

In block 302, in one embodiment, a computer having the user-friendly operating system 102 is powered on. Also, the user-friendly operating system 102 is loaded.

In block 304, user authentication is conducted. In one embodiment, a camera 120 attached to or embedded in the computer obtains a face image of the user. The user-friendly operating system 102 conducts the user authentication according to the face image.

If the user is not authenticated, the process for making the Internet phone call will be ended, in block 318. In one embodiment, the user-friendly operating system 102 provides an authentication error message and ends the process for making an Internet phone call.

If the user is authenticated, the user-friendly operating system 102 will check if an Internet phone call service is started, in block 306. In one embodiment, if the user is authenticated, the application programs (e.g., Internet phone call 104, audio player 106, video player 108, digital photo frame 110, instant message 112, email manager 114, web browser 116, etc.) in the customized application program list of the user will be started. The user-friendly operating system 102 automatically signs into the Internet phone call application program 104 (e.g., SKYPE). The user-friendly operating system 102 can keep checking until the starting and sign-in process for the Internet phone call application program 104 is completed.

If the Internet phone call service is started, a contact list is obtained, in block 308. In one embodiment, the user-friendly operating system 102 signs the user into the Internet phone call application program 104, and the contact list of the user can be automatically shown on the screen.

Then, a check is made to determine whether the user is willing to select a contact from the contact list, in block 310. In one embodiment, the contact list of the user is loaded and displayed on the screen waiting for the user to select a contact. The user can set a contact by selecting a contact from the contact list and otherwise by manually entering contact information for a contact, in block 312, in one embodiment. The user-friendly operating system 102 can keep checking until the user sets a contact.

After the user sets the contact, an Internet phone call will be made, in block 314. The Internet phone call application program 104 automatically dials the number of the contact, establishes connection with the contact. The user makes a phone call with the contact.

In block 316, the Internet phone call is ended. In one embodiment, the Internet phone call is ended if the user hangs up the Internet phone call.

In block 318, the process for making the Internet phone call is ended. In one embodiment, the user finishes the Internet phone call and the user-friendly operating system 102 can close the Internet phone call application program 104. In one embodiment, the user can continue to use other application programs in the customized application program list. The user can also shut off the computer.

During the process of making the Internet phone call, the user-friendly operating system 102 can provide a sign-in error message when it fails to sign in the Internet phone call application program 104. The user-friendly operating system 102 can also provide a contact list error message if the contact list of the user is not obtained. Furthermore, the user-friendly operating system 102 can provide a dialing error message when a connection with the contact is not established. Moreover, the user-friendly operating system 102 can provide a sign-out error message if it fails to sign out of the Internet phone call application program 104.

Furthermore, an authorized administrator or an authenticated user can add the Internet phone call application program 104 to the user's customized application program list. Since the administrator can edit settings for all the users of the user-friendly operating system 102, the administrator can first select the user from all the users of the user-friendly operating system 102, in one embodiment. The administrator/user can input the user's information (e.g., the user's username and password) for the Internet phone call application program 104. The user-friendly operating system 102 can verify whether the user is valid according to the user's information. For example, the user-friendly operating system 102 can use the user's username and password to sign into the Internet phone call application program 104 and, if the sign-in is successful, the user can be regarded valid. If the user is valid, the user-friendly operating system 102 will save the user's information. If the user is invalid, the user-friendly operating system 102 will provide a verification error message to the administrator. Also, the user-friendly operating system 102 will provide a saving error message when it fails to save the user's information. Moreover, the user-friendly operating system 102 can provide multi-language support which can display information in different languages on the screen so as to accommodate users and administrators of different language backgrounds.

Moreover, the administrator/user can also edit the user's information (e.g., username and password) for Internet phone call application program 104. The administrator can first select the user from all the users of the user-friendly operating system 102. The administrator/user can select the user's information for the Internet phone call application program 104 and edit the user's information. The user-friendly operating system 102 can verify whether the user is valid according to the edited user's information. If the user is valid, the user-friendly operating system 102 will save the edited user's information. If the user is invalid, the user-friendly operating system 102 can provide a verify error message to the administrator/user. Also, the user-friendly operating system 102 can provide a saving error message when it fails to save the edited user's information.

Furthermore, the administrator/user can also delete the user's information (e.g., username and password) for Internet phone call application program 104. Similar to the above, the administrator can first select the user from all the users of the user-friendly operating system 102. The administrator/user can select the user's information for the Internet phone call application program 104 and delete the user's information. The user-friendly operating system 102 can prompt a confirm message asking whether the administrator/user is sure of deleting the user's information. If the administrator/user is sure, the user-friendly operating system 102 can delete the user's information and prompts a successful message for the deletion. Furthermore, if the administrator/user does not confirm deletion of the user's information, the user-friendly operating system 102 will not conduct the deletion. If the user-friendly operating system 102 fails to delete the user's information, a delete error message will be provided.

Advantageously, the administrator/user can add, edit, or delete a contact of the user. The contact can be a subscriber of the Internet phone call application program 104. The contact can also be a telephone number of a conventional phone or cell phone. Similarly, the administrator can first select the user from all the users of the user-friendly operating system 102. To add a contact, the administrator/user can input contact information (a username or e-mail address of the contact if the contact is a subscriber of the Internet phone call application program 104 or a telephone number of the contact) and set a contact icon to be shown in the contact list. To edit a contact, the administrator/user can select the contact and edit the contact information (e.g., the username, the e-mail address, or the telephone number) of the contact. When adding or editing a contact, the user-friendly operating system 102 can check whether the contact information (e.g., the username, the e-mail address, or the telephone number) is valid. If the contact information is valid, the contact information will be saved. The user-friendly operating system 102 can provide a contact information error message if the contact information is invalid. The user-friendly operating system 102 will provide the saving error message when it fails to save the contact information. To delete a contact, the administrator/user can select the contact and delete the associated contact information. The user-friendly operating system 102 can prompt a confirm message asking whether the administrator/user is sure of deleting the contact information. If the administrator/user confirms deletion of the contact information, then the user-friendly operating system 102 can delete the contact information and prompts a successful message for the deleting. Furthermore, if the administrator/user does not confirm deletion of the contact information, the user-friendly operating system 102 will not delete that information. If the user-friendly operating system 102 fails to delete the contact information, a delete error message will be provided.

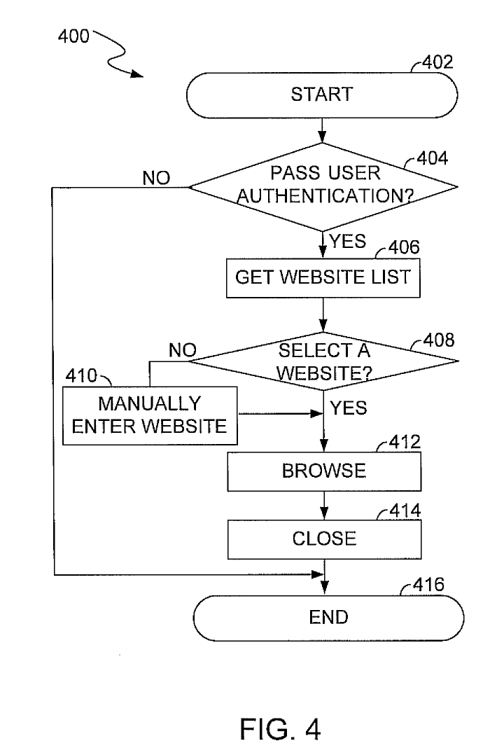

FIG. 4 illustrates a flowchart 400 of a method for browsing websites according to one embodiment of the present invention. Although specific steps are disclosed in FIG. 4, such steps are exemplary. That is, the present invention is well suited to performing various other steps or variations of the steps recited in FIG. 4. FIG. 4 is described in combination with FIG. 1.

In block 402, in one embodiment, a computer having the user-friendly operating system 102 is powered on. Also, the user-friendly operating system 102 is started.

In block 404, user authentication is conducted. In one embodiment, the camera 120 obtains a face image of the user, and the user-friendly operating system 102 conducts the user authentication by face recognition.

If the user is not authenticated, the process for browsing websites will be ended, in block 416. In one embodiment, the user-friendly operating system 102 provides an authentication error message and ends the process for browsing websites.

If the user passes the user authentication, a website list is obtained, in block 406. In one embodiment, the user-friendly operating system 102 starts the Web browser application program 116 automatically and loads the website list of the user.

If the website list is obtained, a check is made to determine whether the user is willing to select a website from the website list, in block 408. In one embodiment, the website list of the user is loaded and displayed on the screen waiting for the user to select a website. The user can set a website to browse by selecting a website from the website list and otherwise by manually entering website address for a website, in block 410, in one embodiment. The user-friendly operating system 102 can keep checking until the user sets a website.

After the user sets a website, the website can be loaded and browsed, in block 412. The web browser application program 116 can open Web pages of the website and enable the user to browse the website in a browsing window. During browsing, the user can select other websites from the website list and switch to other websites for browsing, in one embodiment. Furthermore, the user-friendly operating system 102 can provide a website browsing error message if a web page of the website is not opened.

In block 414, the browsing window for browsing the websites is closed. In one embodiment, the user closes the browsing window.

In block 416, the process for browsing websites is ended. In one embodiment, the user finishes browsing websites and the user can continue to use other application programs in the customized application program list. The user can also shut off the computer.

The administrator/user can add, edit, or delete a website in the user's website list in a manner similar to the manner in which contact information is added, edited and deleted, as already described herein.

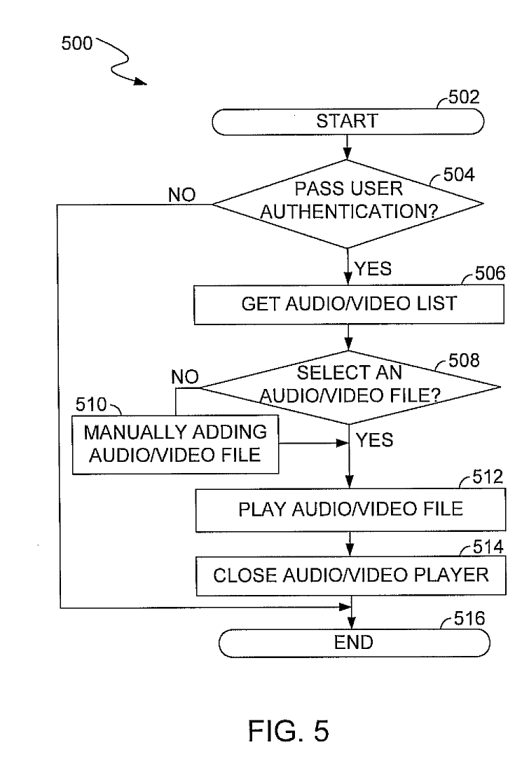

FIG. 5 illustrates a flowchart 500 of a method for playing a video file according to one embodiment of the present invention. The method for playing an audio file is similar to the method for playing a video file. Although specific steps are disclosed in FIG. 5, such steps are exemplary. That is, the present invention is well suited to performing various other steps or variations of the steps recited in FIG. 5. FIG. 5 is described in combination with FIG. 1.

In block 502, in one embodiment, a computer having the user-friendly operating system 102 is powered on. Also, the user-friendly operating system 102 is started.

In block 504, user authentication is conducted. In one embodiment, the camera 120 obtains a face image of the user and the user-friendly operating system 102 conducts the user authentication by face recognition.

If the user is not authenticated, the process for playing a video file will be ended, in block 514. In one embodiment, the user-friendly operating system 102 provides an authentication error message and ends the process for playing a video file.

If the user passes is authenticated, a video file list is obtained, in block 506. In one embodiment, the user-friendly operating system 102 starts the video player application program 108 and the video file list for the user can be shown on the screen.

If the video file list is obtained, a check is made to determine whether the user is willing to select a video file from the video file list, in block 508. In one embodiment, the video file list of the user is loaded and displayed on the screen waiting for the user to select a video file. The user can set a video file to play by selecting a video file from the video file list and otherwise by manually adding a video file, in block 510, in one embodiment. The user-friendly operating system 102 can keep checking until the user sets a video file.

After the user sets the video file, the video file is played, in block 512. During playing, the user can select and play other video files from the video file list, in one embodiment. Furthermore, the user-friendly operating system 102 can provide a video file playing error message when a video file fails to play.

In block 514, the video player application program 108 is closed. In one embodiment, the user closes the video player application program 108.

In block 516, the process for playing a video file is ended. In one embodiment, the user finishes watching the video file and the user can continue to use other application programs in the customized application program list. The user can also shut off the computer.

As mentioned above, the audio player application program 106 can play audio files in a similar manner, in one embodiment. Also, the administrator/user can add, edit, or delete an audio or video file in the respective list in a manner similar to the manner in which contact information is added, edited and deleted, as already described herein.

The user-friendly operating system 102 can not only be installed in the computer but can also be applied to other electronic devices (e.g., a video phone, a digital photo frame device).

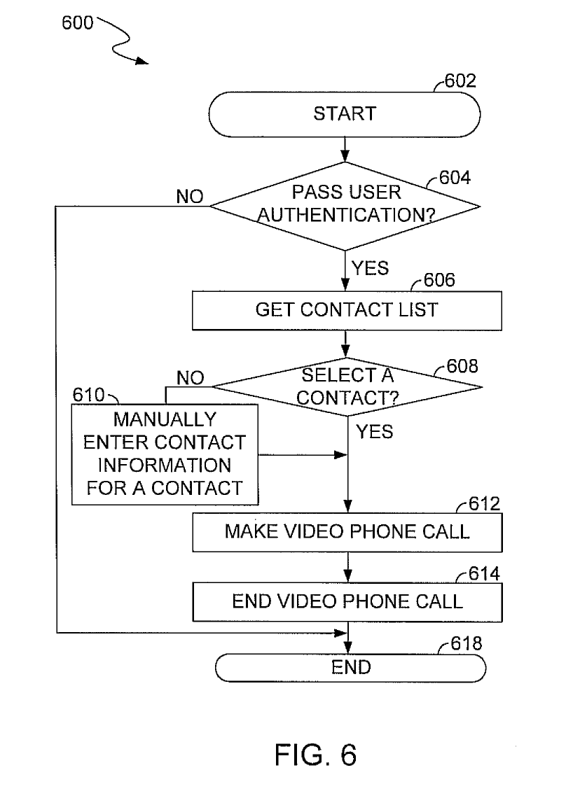

FIG. 6 illustrates a flowchart 600 of a method for making a video phone call according to one embodiment of the present invention. Although specific steps are disclosed in FIG. 6, such steps are exemplary. That is, the present invention is well suited to performing various other steps or variations of the steps recited in FIG. 6. FIG. 6 is described in combination with FIG. 1.

In block 602, a video phone is started. In one embodiment, the user pushes a start button to start the video phone. At the same time, the user-friendly operating system 102 of the video phone is also started.

In block 604, user authentication is conducted. In one embodiment, a camera of the video phone obtains a face image of the user. The user-friendly operating system 102 conducts the user authentication by face recognition.

If the user does not pass the facial authentication, the video phone will be ended, in block 618. In one embodiment, the user-friendly operating system 102 provides an authentication error message and ends the video phone.

If the user passes the facial authentication, a contact list of the user is obtained, in block 606. In one embodiment, the user-friendly operating system 102 loads the contact list of the authenticated user and displays the contact list on the screen of the video phone.

In block 608, a check is made to determine whether the user is willing to select a contact from the contact list. In one embodiment, the contact list of the user is loaded and displayed on the screen waiting for the user to select a contact. The user can set a contact by selecting a contact from the contact list and otherwise by manually entering contact information for a contact, in block 610, in one embodiment. The user-friendly operating system 102 can keep checking until the user sets a contact.

In block 612, a phone call is made. In one embodiment, the user selects one contact from the contact list. The video phone call application program automatically dials the number of the contact, establishes connection with the contact. The user makes a video phone call with the contact.

In block 614, the video phone is ended. In one embodiment, the user hangs up the video phone and the user-friendly operating system 102 ends the video phone.

In block 616, the process for making the Internet phone call is ended.

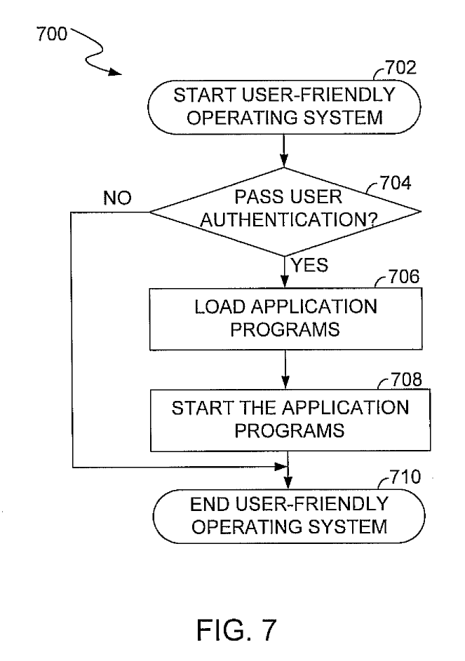

FIG. 7 illustrates a flowchart 700 of a method for providing user-friendly services according to one embodiment of the present invention. Although specific steps are disclosed in FIG. 7, such steps are exemplary. That is, the present invention is well suited to performing various other steps or variations of the steps recited in FIG. 7. FIG. 7 is described in combination with FIG. 1.

In block 702, a user-friendly operating system 102 is started. In one embodiment, a user pushes a power button of a computer and starts the user-friendly operating system 102 installed in the computer.

In block 704, user authentication is conducted. In one embodiment, the user-friendly operating system 102 conducts the user authentication (authentication by means of face recognition) cooperating with the camera 120.

If the user is not authenticated, the user-friendly operating system 102 will be ended, in block 710. In one embodiment, the user-friendly operating system 102 will provide an error message and ends the user-friendly operating system 102.

If the user is authenticated, settings of the user will be loaded, in block 706. In one embodiment, the user-friendly operating system 102 loads the settings of the user and displays a customized visual style for a graphical user interface on the screen.

In block 708, a number of application programs (e.g., Internet phone call application 104, audio player 106, video player 108, digital photo frame application 110, instant message application 112, email manager 114, web browser 116, etc.) are enabled. In one embodiment, the user-friendly operating system 102 starts the application programs listed in a customized application program list of the user. The user operates the application programs with simplified operations. For example, the user does not need to manually sign in as a subscriber of the application programs. Instead, once the user is recognized and authenticated, the user-friendly operating system 102 will automatically do it for the user according to the settings of the user loaded before.

In block 710, the user-friendly operating system 102 is ended. In one embodiment, the user finishes using the application programs and ends the user-friendly operating system 102.

To summarize, the user-friendly operating system 102 makes the operation of the computer more convenient and effective. With facial authentication, the user does not need to enter a username and a password to startup an operating system, in one embodiment. In addition, the user may not need to worry about the potential risks that will happen if the password is lost or stolen. The user-friendly operating system 102 also provides customized (e.g., user-defined) visual styling of a graphical user interface and simplifies the operation of the application programs, in one embodiment. The user-friendly operating system 102 can enable users who do not have basic computer knowledge to operate the computer and to enjoy the entertainment and convenience provided by the computer.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A system for providing computer services, said system comprising:
a camera for obtaining recognition information for a user; and
an electronic device operable for executing a first operating system for conducting user authentication according to said recognition information and for automatically operating a user-defined application program after said user passes said user authentication.

2. The system of claim 1, wherein said recognition information comprises a face image of said user.

3. The system of claim 1, wherein said user-defined application program is selected from the group consisting of an Internet phone call application, audio player, video player, digital photo frame, instant message application, email manager and Web browser.

4. The system of claim 1, wherein said electronic device only operates said user-defined application program after said user passes said user authentication.

5. The system of claim 1, wherein said electronic device is further operable for executing a second operating system, wherein said first operating system is embedded in said second operating system.

6. The system of claim 5, wherein said first operating system starts before said second operating system when said electronic device starts.

7. The system of claim 5, wherein one of said first and second operating systems is selected after said user passes said user authentication.

8. The system of claim 5, wherein said electronic device further comprises a certain item for switching to said second operating system while said first operating system operates, said certain item selected from the group consisting of: a specified button on said electronic device, and an icon displayed on said electronic device.

9. A computer-implemented method of providing computer services, comprising:
obtaining recognition information for a user by a camera;
conducting user authentication according to said recognition information;
loading a user-defined application program after said user passes said user authentication; and
starting said application program if said user is authenticated.

10. The method of claim 9, wherein said user-defined application program is selected from the group consisting of an Internet phone call application, audio player, video player, digital photo frame, instant message application, email manager and Web browser.

11. The method of claim 9, further comprising displaying a user-defined audio file list when said user-defined application program comprises an audio player.

12. The method of claim 9, further comprising displaying a user-defined video file list when said user-defined application program comprises a video player.

13. The method of claim 9, further comprising displaying a user-defined website list when said user-defined application program comprises a Web browser.

14. The method of claim 9, further comprising obtaining a user-defined contact list including a plurality of contacts when said user-defined application program comprises an Internet phone call application.

15. The method of claim 14, further comprising selecting a contact in said contact list after said contact list is obtained and otherwise manually entering contact information.

16. The method of claim 14, wherein said user-defined contact list comprises a plurality of photos for said plurality of said contacts.

17. The method of claim 9, wherein said recognition information comprises a face image of said user.

18. A computer-readable medium having computer-executable instructions for performing a method of providing computer services, said method comprising:
obtaining recognition information for a user from a camera;
using said recognition information to authenticate said user;
loading a user-defined application program after said user passes said user authentication; and
starting said application program if said user is authenticated.

19. The computer-readable medium of claim 18 wherein said user-defined application program is selected from the group consisting of an Internet phone call application, audio player, video player, digital photo frame, instant message application, email manager and Web browser.

20. The computer-readable medium of claim 18 wherein said method further comprises displaying a user-defined audio file list when said user-defined application program comprises an audio player.

21. The computer-readable medium of claim 18 wherein said method further comprises displaying a user-defined video file list when said user-defined application program comprises a video player.

22. The computer-readable medium of claim 18 wherein said method further comprises displaying a user-defined website list when said user-defined application program comprises a Web browser.

23. The computer-readable medium of claim 18 wherein said method further comprises obtaining a user-defined contact list including a plurality of contacts when said user-defined application program comprises an Internet phone call application.

24. The computer-readable medium of claim 18 wherein said recognition information comprises a face image of said user.
